(19) United States
(12) Patent Application Publication
(10) Pub. No.: US 2026/0229436 A1
(43) Pub. Date: Aug. 6, 2026

(54) SWITCHING DEVICE

(71) Applicant: Ellenberger & Poensgen GmbH, Altdorf (DE)

(72) Inventors: Lothar HOFMEISTER, Neumarkt (DE); Stefan HOLBE, Nuernberg (DE); Julian KAISER, Erlangen (DE); Hendrik-Christian KOEPF, Nuernberg (DE)

(73) Assignee: Ellenberger & Poensgen GmbH, Altdorf (DE)

(21) Appl. No.: 19/461,135

(22) Filed: Jan. 27, 2026

(30) Foreign Application Priority Data
Jan. 27, 2025 (DE) 10 2025 102 793.5

(51) Int. Cl. H01H 50/56; H01H 50/18; H01H 50/54

(52) U.S. Cl. CPC H01H 50/56; H01H 50/18; H01H 50/546

(57) ABSTRACT

A switching device having an electrical drive, which includes an armature movably supported along a first adjustment path. A mechanical switch includes a fixed contact and a contact bridge with a moving contact. The contact bridge being movably supported in relation to the fixed contact along a second adjustment path such that the moving contact rests against the fixed contact in a closed state of the mechanical switch. The moving contact being situated at a distance from the fixed contact in an opened state. The contact bridge is movably supported in relation to the armature. An apparatus compensates for a burn-off of the moving contact and/or the fixed contact. The switching device is designed such that, when the mechanical switch is in the closed state, a start of a movement of the armature results in a start of a movement of the contact bridge.

This nonprovisional application claims priority under 35 U.S.C. § 119(a) to German Patent Application No. 10 2025 102 793.5, which was filed in Germany on January 27, 2025, and which is herein incorporated by reference.

### BACKGROUND OF THE INVENTION

### Field of the Invention

The invention relates to a switching device. The switching device comprises an electrical drive, which includes an armature movably supported along a first adjustment path, and a mechanical switch, which includes a movably supported contact bridge having a moving contact and a fixed contact.

### Description of the Background Art

Circuit-breakers are customarily used to protect an electrical line or a device against a malfunction of the assigned circuit, for example an excessive applied electrical voltage or an excessive flowing electrical current. This occurs, for example, when there is prior damage to the device to be protected or to the electrical line. In this case, an interruption of the current flow takes place with the aid of the circuit-breaker, so that further damage is avoided.

To interrupt the current flow, the circuit-breaker includes a switching device having a switch. To provide a contact protection and for the purpose of easy mounting, the switch is arranged within a housing. The switch is designed, for example, as a semiconductor switch. For structural reasons, it has an inner resistance, for which reason it heats up during operation, at least if a comparatively high electrical current is conducted. A cooling is thus required. An efficiency is also reduced.

In one alternative, the switch is provided with a mechanical design, for which reason an electrical resistance is reduced. The mechanical switch usually includes a moving contact, which may be positioned in relation to a fixed contact. When they are situated at a distance from each other, the mechanical switch is opened. When the moving contact rests against the fixed contact, the mechanical switch is closed, i.e. in a closed state, so that an electrical current flow over the mechanical switch is made possible. In one refinement, an electromechanical drive is also present, which also acts upon the moving contact. It is thus possible to open or to close the mechanical switch with the aid of the electromechanical drive.

During an opening of the mechanical switch, i.e., when the moving contact is moved away from the fixed contact, it is possible for an arc to initially form therebetween, so that a current flow continues over the mechanical switch. The arc only collapses if the electrical voltage present at the circuit-breaker is higher than the (electrical) arc voltage needed to maintain the arc.

The moving contact and the fixed contact heat up due to the arc, so that they partially melt at least on the surface. A portion of the particular material also evaporates. During the subsequent solidification, the shape of the moving contact and the fixed contact changes, and they have a slightly flatter shape, due to the lack of material. When the moving contact is thus moved into its original position during the subsequent closing of the switch, a contact pressure at which the moving contact rests against the fixed contact is lower, and a small air gap may possibly be present between the moving contact and the fixed contact. This increases the electrical resistance, and it is possible for an arc to form between the moving contact and the fixed contact even in the closed state, which results in an excessive heating.

To remedy this situation, an apparatus for compensating for a burn-off of the moving contact and/or the fixed contact is usually present. It usually includes a carrier, on which the moving contact is movably supported between two stops, namely in the direction in which the moving contact is moved to open the mechanical switch. The moving contact is pretensioned with the aid of a contact pressure spring supported on the carrier and the moving contact. To open and close the mechanical switch, the carrier is moved, for example, with the aid of the drive. During closing, the carrier continues to be moved when the moving contact is already resting against the fixed contact and thus can no longer be moved. This then results in a further tensioning of the contact pressure spring. With the aid of the contact pressure spring, it is thus ensured that the moving contact always rests against the fixed contact in the closed state, even if they change during use, for example, due to a burn-off. During the opening of the mechanical switch, however, the carrier continues to be moved until a relative movement of the moving contact in relation to the carrier is no longer possible due to the stops. This therefore results in a reduced switching speed.

### SUMMARY OF THE INVENTION

It is therefore an object of the invention to provide a particularly suitable switching device, a switching speed being advantageously increased and/or manufacturing costs reduced.

The switching device can be used, in particular, to switch an electrical current, i.e., in particular, to generate and/or interrupt an electrical current flow. For this purpose, the switching device advantageously has two states, namely an electrically conductive state, which is also referred to as the closed state. In this case, it is possible to conduct the electrical current with the aid of the switching device. In the other state, which is referred to as the opened or electrically non-conductive state, in particular, an electrical current flow over the switching device is not possible. For example, the switching device is manually actuated/actuatable, so that the switching device is a manual switch. Alternatively or in combination herewith, it is possible, for example, to actuate the switching device electrically and thus, in particular, remotely. In a further alternative, the switching device is actuated, for example, manually, advantageously depending on certain conditions. The switching device is suitably a constituent part of a circuit-breaker or a contactor.

The circuit-breaker can be used, for example, to protect a device, and the circuit-breaker is, for example, a device circuit-breaker. Alternatively or in combination herewith, the circuit-breaker is used to protect a line and is thus a line circuit-breaker. In particular, the circuit-breaker is used in a DC circuit, for example between a load and a DC voltage source or the like, so that, in particular, a circuit is formed. An electrical DC voltage between 400 V and 650 V, i.e., in particular, a higher DC voltage, is preferably present in the DC circuit. The circuit breaker is preferably used to protect an actuator in an industrial plant. The actuator forms, in particular, the load. The circuit-breaker or at least the switching device is advantageously used in the area of industrial automation. In particular, the electrical voltage switched with the aid of the circuit-breaker/switching device is 24 V, 48 V, 380 V, 650 V, 760 V. In one alternative, the circuit-breaker is used to protect, or at least the switching device is used to switch, a street light system, a ship electrical system, railroad application infrastructure, a railway application drive, or in the area of electrified aeronautics. In a further alternative, the circuit-breaker/switching device is used in the expansion and integration of renewable energy generators in separate networks, in private homes, in greenhouses, in the electrification of road-bound mobility (electromobility), agriculture, or in construction site vehicles. The electrical (DC) voltage used is, for example, between 1,500 V and 3,000 V or is 110 V, 380 V, 400 V, 800 V, 1,000 V, 1,500 V, 3,000 V. In summary, as an alternative to its application in an industrial plant, the circuit-breaker/switching device is used, for example, in an electric vehicle, such as a motor vehicle, an aircraft, or a ship/boat.

In an example, the switching device can be designed as a disconnecting switch or as constituent part thereof, which is also referred to as a disconnector. For example, the switching device comprises a mechanical lever, with the aid of which the switching state of the control device may be changed.

The switching device advantageous can comprise two device connections, to which further components of the circuit may be connected in the mounted state. The device connections are suitable, in particular provided and configured, for this purpose. A cable or a busbar is advantageously connected to the particular device connection for this purpose, a cross-section thereof being between, for example, 10 mm² and 100 mm² or between 25 mm² and 92 mm². The cross-section is, for example, 16 mm², 25 mm², or 35 mm². The cross-section is, for example, 6 mm², between 6 mm² and 16 mm², or between 16 mm² and 50 mm². In particular, the device connections are designed in the manner of cage clamps or at least comprise the latter. The two device connections are advantageously connected to each other electrically with the aid of a current path. For example, the two device connections are electrically contacted directly to each other with the aid of this current path, or a further component is electrically connected in series to the current path, via which and via the current path the two device connections are then electrically connected to each other.

The switching device suitably can include a housing, which is preferably manufactured from a plastic. In particular, all other components of the switching device are suitably arranged in the housing. The housing advantageously forms an outer boundary of the switching device. A contact protection is thus provided, and the components are protected against environmental influences. For example, the housing is designed as a single piece, which increases a tightness. Alternatively, the housing is assembled from multiple housing parts. The housing is particularly preferably formed with the aid of two shells set against each other. This makes a mounting easier. The current path is suitably arranged in the housing. The possible device connections are advantageously introduced into the housing, so that an electrical contacting of the current path is made possible from outside the housing.

The switching device can include a mechanical switch, which is suitably arranged in the possible housing. The mechanical switch advantageously forms a constituent part of the possible current path. The mechanical switch is thus electrically connected between the two device connection of the switching device. It is therefore possible to switch an electrical current flow over the current path, using the mechanical switch. For example, the current path also includes further components or, for example, the current path is formed only with the aid of the mechanical switch as well as possible electrical lines, such as busbars, which lead to the mechanical switch. Manufacturing costs are thus reduced.

The mechanical switch can include a contact bridge having a moving contact. For example, the contact bridge comprises a bridge body, to which the moving contact is fastened. For example, the moving contact forms a single piece with the bridge body, or the moving contact and the bridge body are advantageously made from different materials. In particular, the bridge body is manufactured from a copper. For example, the moving contact is permanently soldered, permanently welded, or permanently riveted to the bridge body. In particular, the contact bridge, suitably the possible bridge body, is strip-shaped and thus has a main extension direction. The moving contact is preferably assigned to one of the ends of the contact bridge in the main extension direction.

The mechanical switch can also include a fixed contact. The fixed contact is preferably a constituent part of a connection. The connection suitably includes a connection body, which is made, for example, from a copper. For example, the fixed contact is made from the same material as the connection body and is, in particular, formed thereon. However, they are advantageously manufactured from different materials, preferably from a metal. For example, the fixed contact is permanently soldered, permanently welded, or permanently riveted to the connection body. The connection, or at least the fixed contact, is advantageously held rigidly on the possible housing, so that a relative movement of the fixed contact with respect to the housing is not possible.

The contact bridge can be movably supported in relation to the fixed contact along a second adjustment path, in particular, therefore, also in relation to the possible housing. It is thus possible to move the contact bridge and therefore also the moving contact in relation to the fixed contact. The mechanical switch is designed in such a way that the moving contact rests against the fixed contact in a/the closed state of the mechanical switch, a direct mechanical contact therebetween being advantageously implemented. In an/the opened state, however, the moving contact is situated at a distance from the fixed contact. To change the state of the mechanical switch, the contact bridge is thus moved along the second adjustment path, the distance of the moving contact from the fixed contact being changed.

In particular, the movement of the contact bridge may be limited in the one direction by the moving contact resting against the fixed contact. During the movement of the contact bridge in the opposite direction, however, a movement of the two contacts away from each other takes place, so that, in particular, an air gap is formed therebetween. In this state, the mechanical switch is preferably electrically non-conductive and/or opened.

The switching device can comprise an electrical drive, which is suitably also arranged in the possible housing. The electrical drive includes an armature, which is movably supported along a first adjustment path. The armature is, in particular, driven. The first adjustment path is preferably limited by two stops, so that the armature may be moved between the two stops. The electrical drive advantageously has an electrical coil, which is suitably held in a stationary manner. In other words, the electrical coil is particularly preferably rigidly fastened to the possible housing, for example directly or via additional components. Current is supplied to the electrical coil during the operation of the electrical drive. The armature is designed as or comprises, in particular, a permanent magnet. Alternatively, the armature advantageously comprises a ferromagnetic component. The first adjustment path is preferably situated on an axis of the electrical coil. For example, the armature is surrounded by the electrical coil on the circumferential side or is offset therefrom along the axis thereof. The electrical drive is preferably designed in such a way that, during the operation of the drive, i.e., in particular, when current is supplied to the electrical coil, the armature is moved along the axis of the electrical coil, that is, along the first adjustment path. The movement of the armature is preferably limited by the possible stops, preferably only thereby.

The armature can be operatively connected to the contact bridge, so that the mechanical switch is driven with the aid of the electrical drive. By operating the electrical drive, it is thus possible to change the (switching) state of the mechanical switch, i.e., to place the latter into the closed and/or opened state. The first adjustment path is particularly preferably in parallel to the second adjustment path, which makes a construction easier.

The contact bridge can be movably supported in relation to the armature. It is thus possible to adjust the contact bridge in relation to the armature, at least to a limited extent. The direction in which the contact bridge may be adjusted/moved in relation to the armature is advantageously in parallel to the first adjustment path and/or the second adjustment path. A construction is thus simplified.

The switching device furthermore can comprise an apparatus for compensating for a burn-off of the moving contact and/or the fixed contact. If a burn-off of the fixed contact or the moving contact occurs, i.e., if an expansion thereof, in particular, is reduced due to a material loss or another change in shape, this is compensated for with the aid of the apparatus, so that the moving contact continues to rest against the fixed contact, preferably over the entire area, in the closed state of the mechanical switch. In summary, the apparatus is thus suitable, in particular provided and configured, to compensate for the burn-off of the moving contact and/or the fixed contact, so that they rest directly against each other mechanically in the closed state. If a removal of the material of the moving contact/fixed contact thus takes place, this is compensated for with the aid of the apparatus. In particular, the distance of the contact bridge from the armature in the closed state may be varied, suitably depending on the intensity/scope of the burn-off, which is advantageously made possible due to the movable support of the contact bridge in relation to the armature. The second adjustment path is therefore not constant, and an end of the second adjustment path is predefined, for example, with the aid of the apparatus. Alternatively or in combination herewith, the apparatus is also used, for example, for tolerance compensation and is suitable, in particular provided and configured, for this purpose. As a result, in particular, manufacturing tolerances, material tolerances, and/or tolerances in assembly are compensated for. In summary, the apparatus is used, in particular, to ensure that the moving contact always rests against the fixed contact in the closed state. In particular, the apparatus is thus used for so-called overtravel compensation.

The switching device can also be designed in such a way that, when the mechanical switch is in the closed position, a start of a movement of the armature results in a start of a movement of the contact bridge. In particular, the apparatus is used for this purpose, at least in part, so that it is ensured thereby that the start of the movement of the armature results in the start of the movement of the contact bridge. A movement of other constituent parts of the mechanical switch and/or the switching device advantageously does not occur until the start of the movement of the armature when the mechanical switch is to be opened. In particular, if the mechanical switch is in the closed state, and a force acts upon the armature along the first adjustment path, a force is thus introduced into the contact bridge essentially without delay, it being directed in parallel to the second adjustment path. The two adjustment paths are advantageously in parallel to each other and thus also the active forces. For example, the switching device is designed in such a way that the start of the movement of the armature in both directions along the first adjustment path results in the start of the movement of the contact bridge in the particular direction. However, this particularly preferably applies only to the direction resulting in an opening of the mechanical switch. A construction is thus simplified.

Due to a design of this type, a dead time thus essentially does not exist, and an operation of the electrical drive, in particular the start of the supply of current to the possible electrical coil, which results in the movement of the armature, results directly in the movement of the contact bridge and thus in the opening of the mechanical switch. An electrical current conducted thereover is thus interrupted comparatively quickly. For this purpose, it is not necessary to design the electrical drive to be comparatively powerful and to apply a comparatively high force/acceleration to the armature, for which reason an overall size and a weight and thus also manufacturing costs are reduced.

For example, the switching device can comprise only the mechanical switch. However, the switching device particularly preferably also comprises a semiconductor switch, which is designed, for example, as a field-effect transistor, such as a MOSFET or as an IGBT or a GTO. The semiconductor switch is electrically connected in series to the mechanical switch. This makes it possible to first interrupt the electrical current with the aid of the semiconductor switch and to subsequently open the mechanical switch. The formation of an arc is thus avoided, a galvanic isolation nevertheless taking place. Alternatively, for example, the semiconductor switch is electrically connected in parallel to the mechanical switch. If the mechanical switch is opened, an arc, however, being formed there, it is possible to briefly place the semiconductor switch into the electrically conductive state, for which reason the electrical current now being conducted over the switching device is conducted with the aid of the semiconductor switch. As a result, the arc collapses, so that the electrical current flow over the mechanical switch is interrupted. The semiconductor switch is then placed again into the electrically non-conductive state. In this case, the arc does not form again, and the electrical current is interrupted. Alternatively, the semiconductor switch is placed into the electrically conductive state prior to opening the mechanical switch. If the mechanical switch is then placed into the opened state, the electrical current is conducted with the aid of the semiconductor switch, for which reason no arc is formed in the mechanical switch. Afterwards, the semiconductor switch is also placed into the non-conductive state, so that electrical current is no longer conducted over the switching device.

For example, the electrical drive can comprise only a single electrical coil. Alternatively, the electrical drive comprises multiple electrical coils of this type, so that the force provided with the aid of the drive is increased. The electrical drive is designed, for example, as a moving magnet actuator. The armature, which is movably supported, is also assigned to the moving magnet actuator. In addition, the moving magnet actuator includes a drive unit having the or multiple electrical coil(s), to which current is supplied during the actuation of the electrical drive, so that a magnetic interaction takes place between the coils and the armature. The electrical coils are suitably held in a stationary manner. Since the electrical coil(s) is/are held in a stationary manner, a construction is simplified, and, with the except of the components needed for the support, no further movable components or electrical connections are needed between the movable components, namely the armature, and the stationary components of the moving magnet actuator. A friction of the moving magnet actuator, which is also referred to in the following only as the actuator, is thus also reduced.

The drive unit can comprise two electrical coils, which are, for example, of the same design. However, the two electrical coils are at least offset from each other along a longitudinal axis and arranged concentrically thereto. The armature is situated, in particular, on the longitudinal axis and is movably supported along the latter, which is therefore, in particular, in parallel to the first adjustment path. In a switching state of the mechanical switch, the armature is situated in an air gap present between the two electrical coils, where it is held, for example, with the aid of a magnetic shorting plate. In the other switching state, however, the armature is offset along the longitudinal axis, on which, in particular, the axes of the electrical coils are situated. In a further alternative, for example, the armature is offset in relation to the shorting plate in each of the two states.

Since the number of movable constituent parts of the moving magnet actuator, in particular only the actuator, is comparatively small, and they have, in particular, a comparatively low weight, a dynamic of the actuator is comparatively high. An inertia is thus reduced during the actuation of the mechanical switch. As a result, a comparatively rapid switching is made possible with the aid of the switching device.

For example, the second adjustment path can be curved. However, the second adjustment path is particularly preferably in a straight line. The second adjustment path is, in particular, perpendicular to the extension of the contact bridge. A construction is thus simplified. For example, the mechanical switch comprises only a single moving contact. However, the mechanical switch particularly preferably includes a further moving contact, which is preferably also a constituent part of the contact bridge. A further fixed contact, which is, in particular, a constituent part of a further connection, is assigned to the further moving contact. The two moving contacts, the two fixed contacts, and/or the two connections are advantageously of the same design. The mechanical switch is advantageously designed in such a way that the two moving contacts rest against the fixed contact assigned in each case when the mechanical switch is in the closed state, i.e., when the mechanical switch is in the electrically conducting (conductive) state. Each moving contact is then moved away from the fixed contact assigned in each case by moving the contact bridge along the second adjustment path. The mechanical switch is therefore suitably designed in the manner of a double interrupter, for which reason the electrical voltage present between each fixed contact and the assigned moving contact is reduced in the opened (switching) state of the mechanical switch. As a result, a formation of an arc is prevented there, or this only takes place if a comparatively high electrical voltage is present. The apparatus is preferably also assigned to the further moving contact and/or the further fixed contact, so that the particular burn-off thereof is compensated for, and/or possible tolerances are equalized.

An arc chute can be assigned to the fixed contact and the moving contact. In particular, an extinguishing of an arc formed therebetween takes place with the aid of the arc chute when the mechanical switch is opened. The arc chute advantageously comprises multiple quenching plates or the like for this purpose. These are made from a metal and/or a ceramic. If the two moving contacts and the two fixed contacts are present, two corresponding arc chutes are preferably present.

The arc chute can also comprise a blowout arrangement, such as a permanent magnet and/or a steel core. The blowout arrangement preferably comprises one or multiple blowout plates, between which the quenching plates are arranged. A magnetic field is provided with the aid of the blowout arrangement, so that the Lorentz force, based on which the arc is driven between the quenching plates, acts upon the arc present between the moving contact and the fixed contact.

If the mechanical switch is in the opened position, it is possible, for example, to move the contact bridge with the aid of the armature. In other words, it is possible to apply a force to the contact bridge along the second adjustment path with the aid of the armature, so that the mechanical switch is transferred into the closed state. In particular, they are mechanically coupled for this purpose with the aid of an at least partially length-variable component, for example a spring, a strip, or a filament. The ability to move the contact bridge in relation to the armature, in particular, is thus limited thereby. In summary, the movable support of the contact bridge in relation to the armature is thus implemented, an application of force to the contact bridge with the aid of the armature nevertheless being made possible in both directions along the second adjustment path.

The switching device may also designed in such a way that it is possible, for example, to only transfer the mechanical switch from the closed state into the opened state with the aid of the electrical drive. The transfer from the opened state into the closed state is not possible, for example, with the aid of the electrical drive. In this case, the switching device particularly preferably comprises a return spring, with the aid of which the contact bridge is advantageously impinged upon. The return spring is situated, in particular, on the side of the contact bridge opposite the electrical drive, and a force is applied, in particular, to the contact bridge with the aid thereof. If no further forces are active, i.e., in particular, if no current is being supplied to the electrical drive, the moving contact/moving contacts is/are moved along the second adjustment path with the aid of the return spring, so that the mechanical switch is transferred into the closed state. The return spring is suitable, in particular provided and configured, for this purpose. The contact bridge is, in particular, spring-loaded in the closed state, so that the moving contact rests against the fixed contact in a force-fitting manner.

The switching device can include a slide, which is rigidly fastened to the armature. A relative movement of the slide in relation to the armature is thus avoided, and the slide is also adjusted during the movement of the armature. Since the contact bridge is movably supported in relation to the armature, the contact bridge is also movably supported in relation to the slide. For example, the slide is mechanically fastened directly to the armature. However, they are particularly preferably fastened to each other via an actuating rod, which runs, in particular, in parallel to the first adjustment path and/or the second adjustment path. A construction is thus simplified, and an impact of the electrical drive on the contact bridge is avoided due to the distance implemented with the aid of the actuating rod. The slide and/or the armature is/are preferably rotatably held in place, so that a rotation thereof is avoided, in particular around an axis running in parallel to the first adjustment path. An uncontrolled behavior of the switching device is therefore avoided and a construction simplified.

The device can comprise a compensation element, which is used to move the slide against the contact bridge in the closed state of the mechanical switch and is suitable, in particular provided and configured, for this purpose. The slide thus rests against the contact bridge in the closed state of the mechanical switch, i.e., in particular, when no further forces are active, and/or a movement of the individual constituent parts of the switching device is completed, that is, in particular, in the stationary state. In this case, a force is suitably not applied with the aid of the electrical drive, or this force is at least particular compensated for/nullified at least partially with the aid of the apparatus. In the closed state of the mechanical switch, the slide thus rests against the contact bridge, for example, mechanically, directly or via further constituent parts. Due to the contact of the slide, a direct mechanical introduction of the force acting upon the armature is made possible onto the contact bridge, at least when the force is directed in the direction of the contact bridge. A construction is thus simplified. In particular, the armature and the contact bridge move essentially uniformly, for which reason a comparatively fast opening of the mechanical switch is implemented.

In summary, it is ensured that, in the closed state of the mechanical switch, the armature does not rest against a stop of the first adjustment path, but instead, for example, is moved away therefrom, in particular, with the aid of the compensation element. The amount by which the latter is moved away is set/predefined on the basis of the burn-off and/or the compensation element.

For example, the contact bridge is supported in corresponding guides of the possible housing, which preferably run in parallel to the second adjustment path. A number of necessary components is thus reduced. However, the switching device particularly preferably comprises a contact bridge carrier, which is provided, in particular, with a hollow cylindrical and/or cuboid design. The contact bridge is supported on the contact bridge carrier. The support of the contact bridge along the second adjustment path preferably takes place at least partially with the aid of the contact bridge carrier, which simplifies the construction. In particular, the contact bridge carrier is manufactured from a plastic, so that it is also used for electrical isolation.

The contact bridge can be at least partially adjustable in relation to the contact bridge carrier. For this purpose, the contact bridge carrier has a through-opening running perpendicularly to the second adjustment path, through which the contact bridge is inserted, so that the latter protrudes laterally over the contact bridge carrier, preferably on both sides. The through-opening has a greater extension along the second adjustment path than does the contact bridge, the contact bridge preferably being spring-loaded, so that it is pressed against an end of the through-opening. For example, the possible return spring is used as the spring, or advantageously a contact pressure spring is used, which is supported, in particular, on the contact bridge carrier as well as the contact bridge. In particular, this and/or the movable support of the contact bridge on the contact bridge carrier is a constituent part of the apparatus. In the closed state of the mechanical switch, the contact bridge carrier is advantageously always in the same position, which simplifies the construction. However, the position of the contact bridge in relation to the contact bridge carrier is then dependent on the burn-off of the moving contact/fixed contact.

The slide can be movable in relation to the contact bridge carrier. It is at least possible, in particular, to move the slide and the contact bridge carrier at least partially independently of each other. Despite the different positions of the contact bridge in relation to the contact bridge carrier, it is nevertheless possible to move the slide against the contact bridge when the switch is in the closed state.

The contact bridge carrier and the slide can be guided to each other. Their positions are thus stabilized relative to each other, which increases a robustness. In particular, they are inserted into each other for this purpose. For example, the contact bridge carrier is inserted into the slide, or the slide is advantageously inserted into the contact bridge carrier. The contact bridge carrier preferably has a suitable receptacle for this purpose. For example, a movement of the slide in relation to the contact bridge carrier is prevented only when the slide is resting against the contact bridge, and the latter is situated at the end of the possible through-opening. An application of force by the slide onto the contact bridge carrier is thus possible only via the contact bridge. A construction is thus simplified and a mounting made easier.

However, the slide and/or the contact bridge carrier can also comprise(s) stops corresponding to each other, so that a direct application of force to the contact bridge carrier is made possible, at least when the contact bridge is in a particular position relative to the contact bridge carrier. A load on the contact bridge is thus reduced, and a uniform application of force into the contact bridge carrier is implemented, which results in a uniform adjustment of the contact bridge.

The slide and the contact bridge carrier can be inserted into each other only loosely. By loosely inserting them into each other, it is advantageously possible to only move the contact bridge carrier in a direction along the second adjustment path with the aid of the electrical drive, at least by supplying current the drive. A movement of this type results, in particular, in the opening of the mechanical switch. When moving the armature in the opposite direction, it is not possible, in particular, to transfer force to the contact bridge carrier, due to the loose interconnection. They nevertheless advantageously remain inserted into each other, the extension of the component formed in this way, however, being enlarged. The moving back of the contact bridge carrier advantageously takes place with the aid of the possible return spring. Due to this loose interconnection, it is thus possible to move the contact bridge carrier, and therefore also the contact bridge, partially independently of the electrical drive or to leave it in a corresponding position.

For example, the compensation element can comprise a spring, on which the slide is supported in the closed state of the mechanical switch. The slide rests, for example, directly on the spring in the closed state of the mechanical switch, which is also referred to only as the switch. Alternatively, it acts, for example, upon the armature or the possible actuating rod, so that the slide is indirectly supported on the spring. The slide, in particular also the armature, is moved/pressed in the direction of the contact bridge with the aid of the spring. In other words, the slide is preferably spring-loaded with the aid of the spring in the closed state.

In particular, the spring can be relaxed in the opened state of the mechanical switch, so that no further force is provided with the aid thereof. It is thus possible to provide the latter with a comparatively compact design, since a force is provided with the aid of the spring only for a comparatively short distance. The length of the spring is suitably set to the possible burn-off of the moving contact and/or fixed contact. If the latter is completely burned off, and the mechanical switch is thus damaged, the spring is, in particular, relaxed. Material costs for the spring and a space requirement are therefore reduced. Due to the spring, it is also possible to provide comparatively low, yet reliably acting, forces, so that the slide is moved against the contact bridge and held there. In this case, the spring is, for example, at least already partially relaxed, so that an excessive force is not applied to the contact bridge with the aid of the slide. The mechanical switch is also left in the closed state as long as no opening is desired.

Alternatively or in combination therewith, the compensation element can comprise a first magnet element and a second magnet element. The first magnet element is assigned to the slide and the second magnet element to the contact bridge. In particular, the first magnet element is fastened to the slide. The slide preferably has a receiving opening and/or hollow for this purpose, in which the first magnet element is inserted. Alternatively or in combination therewith, the first magnet element is overmolded, for example, with the material of the slide, which is preferably manufactured from a plastic. A robustness is thus increased and a manufacturing simplified. It is ensured, in particular, that a direct mechanical contact does not take place between the first magnet element and the contact bridge, so that damage is avoided. In addition, a damping also at least partially takes place during the movement of the slide against the contact bridge by means of the material of the slide, so that damage to the first magnet element is further avoided.

For example, the first magnetic element can comprise one or multiple continuations, with the aid of which the contact bridge is at least partially encompassed when the slide rests against the contact bridge. Magnetic field lines provided and/or formed with the aid of the first magnet element are thus at least partially guided around the contact bridge, for which reason the slide is stabilized on the contact bridge. Alternatively or in combination therewith, an air gap between the first and second magnet elements is reduced in this way.

For example, the first magnet element can be designed as a permanent magnet. The second magnet element is made, for example, from a ferromagnetic material. Material costs are thus reduced. Alternatively, the second magnet element advantageously comprises a permanent magnet or is formed thereby. As a result, a force active between the two magnet elements is increased, so that a secure movement of the slide against the contact bridge takes place. In a further alternative, the first magnet element is made, for example, from a ferromagnetic material, and the second magnet element comprises a permanent magnet. A mounting of the switching device is thus simplified. Alternatively, both magnet elements are made from a ferromagnetic material. In this case, they are oriented, in particular, in such a way that, when a current is conducted over the switching device, a magnetic field induced by the contact bridge due to the electrical current is suitably formed, so that the first and second magnet elements attract each other. Manufacturing costs are thus further reduced. In each case, an iron or a steel is advantageously used as the ferromagnetic material.

For example, the second magnet element is worked into the contact bridge, or the contact bridge is, for example, an alloy or designed as a tri-metal or bi-metal. A captive arrangement is therefore implemented.

In particular, the second magnet element can rest against the contact bridge, so that a relative movement thereof in relation to each other is prevented. The position of the contact bridge is this also always predefined on the basis of the second magnet element, and an unforeseen behavior of the switching device is prevented.

The second magnet element can be arranged on the side of the contact bridge opposite the slide. For example, the second magnet element is only loosely placed against the contact bridge or is particularly preferably glued/welded/soldered or riveted thereto, which increases a robustness and makes a mounting easier. Due to the arrangement, during a movement of the two magnet elements toward each other, the contact bridge is moved in the direction of the first magnet element and, in particular, pressed against the slide. As a result, a complicated fastening of the second magnet element to the contact bridge is not necessary. Due to the magnetic force between the two magnet elements, detachment is avoided even if damage to the fastening occurs.

The contact bridge can be surrounded by the second magnet element on the circumferential side, at least along a certain distance, in particular a portion along the main extension direction. The second magnet element is preferably designed in the manner of a ring, through which the contact bridge is inserted during manufacturing. The second magnet element is preferably made from the ferromagnetic material, for example iron, for which reason material costs are comparatively low. Due to the surrounding on the circumferential side, a portion of the second magnet element is thus situated on the side facing the slide, for which reason forces acting therebetween are increased even if only comparatively little material and/or weak magnetic forces is/are present. Manufacturing costs of the first and/or second magnetic element(s) are thus reduced or may be reduced. Due to the surrounding on the circumferential side, it is also ensured that the second magnet element does not become detached from the contact bridge, for which reason a robustness is increased.

The compensation element can comprise an elastomer, via which the slide is connected to the contact bridge. Due to the elastomer, the slide is this always moved against the contact bridge, since the latter rests thereon via the elastomer. The elastomer preferably has a comparatively high modulus of elasticity, but tends to creep, in particular, to a comparative great degree. Due to the elastomer, it is thus also still possible to move the armature and the contact bridge toward each other. In the closed state of the mechanical switch, the armature is preferably situated at a stop of the first adjustment path and is, for example, held there. It is therefore possible, due to the elastomer, to change the position of the armature in relation to the contact bridge even if they are mechanically connected to each other. The burn-off or other tolerances may thus be compensated for. However, if a comparatively fast movement of the armature takes place, namely when the mechanical switch is to be opened, this movement is transferred directly to the contact bridge, in particular, due to the comparatively high modulus of elasticity. Due to the elastomer, manufacturing costs are reduced, and the manufacturing of the switching device is simplified.

The slide and therefore also the armature can be pulled again in the direction of the contact bridge, due to the elasticity of the elastomer, for example, in the closed state of the mechanical switch. As a result, the armature is moved away from the possible stop of the first adjustment path. The elastomer thus acts in the manner of a spring. In a further alternative, for example, a spring, which has a comparatively low spring constant, at least during an elongation, is present instead of the elastomer. During a compression, on the other hand, the spring constant is, in particular, increased.

The compensation element can comprise, for example, a shape memory material, via which the slide is connected to the contact bridge. Due to the shape memory material, the slide is always moved against the contact bridge, the contact bridge being movable in relation to the armature, and is thus displaceable, due to the deformability of the shape memory material. The shape memory material has, in particular, two different states, one of which it assumes when the mechanical switch is in the closed state. This state is advantageously maintained during the complete or at least during the start of the movement of the armature, which results in an opening of the mechanical switch. In summary, to place the mechanical switch into the closed state, the shape memory material preferably has a shape which deviates from the shape which the shape memory material has in the closed state of the mechanical switch.

The shape memory material can be a shape memory polymer or a shape memory alloy. These are advantageously magnetic shape memory alloys. If a magnetic field is not present, a deformability is suitably given or made easier. However, if a magnetic field is present, the shape memory material is placed in a predefined position, in which, in particular, a compression is not possible or may take place only with comparatively high forces. The shape memory material is designed/arranged, in particular, in such a way that it takes the corresponding shape due to the magnetic field provided due to a current flow through the contact bridge.

The compensation element can comprise, for example, a magnetorheological fluid. In particular, the magnetorheological fluid is designed in such a way that, in the absence of a magnetic field, it is present as a fluid, a viscosity being, in particular, comparatively high. However, if the magnetic field is present, the viscosity is suitably reduced, and the magnetorheological fluid is present, for example, as a solid. The magnetic field preferably effectuates this in that a current flow is induced over the contact bridge. In the closed state of the mechanical switch, the magnetorheological fluid is comparatively solid, for which reason a force applied to the armature is then immediately transferred to the contact bridge.

For example, the switching device can be designed in such a way that during/after the start of a movement of the armature, a relative speed of the armature in relation to the contact bridge first increases and reaches a maximum. The maximum is not reached until the movement of the contact bridge has already begun. In particular, the possible slide or another element is mechanically coupled for this purpose to the contact bridge with the aid of a spring/damper system. The damper is advantageously comparatively hard, so that an abrupt force acting upon the armature is essentially immediately introduced into the contact bridge. A comparatively fast switching speed is thus implemented. The spring, on the other hand, is comparatively soft and thus has a comparatively low spring constant, for which reason it is possible to move the contact bridge in relation to the armature into a suitable position, and a movement speed is reduced due to the damper. This is thus essentially used to compensate for the burn-off. In a further alternative, the spring, for example, is not present.

The armature can be connected to a holder, for example, directly or via the possible actuating rod. The holder is rotatable around a rotation axis, which runs in parallel to the second adjustment path. For example, the holder is rigidly fastened to the armature, and the armature is also rotatable around the rotation axis. Alternatively, the holder is rotatable in relation to the armature. The contact bridge is supported in a retaining contour of the holder, which runs around the rotation axis in a helical manner. Two retaining contours of this type are preferably present, and the contact bridge is guided in one of the retaining contours on the opposing sides thereof. In particular, the contact bridge is non-rotatably supported in relation to the rotation axis, or at least a rotation around the rotation axis is prevented. The switching device also preferably has a pressure spring, with the aid of which the contact bridge is supported on the holder.

When the mechanical switch is in the closed state, it is possible to compensate for a burn-off of the moving contact and the fixed contact by means of corresponding compression of the pressure spring. A rotation of the holder around the rotation axis takes place. In other words, it is thus possible, with the aid of the helical support of the contact bridge, to move the contact bridge in relation to the armature and to thus set a distance of one from the other. With the aid of the pressure spring, it is ensured that the moving contact rests against the fixed contact in the closed state of the mechanical switch. At the start of the movement of the armature, a movement of the contact bridge in relation to the holder is initially prevented, due to the mechanical friction during the rotatable support of the holder as well as the friction between the contact bridge and the holder, so that the moving contact is moved away from the fixed contact. In particular, the materials for providing a friction of this type are suitably selected/processed.

The invention further relates to a circuit-breaker having a switching device of this type. The circuit-breaker can be used, in particular, to interrupt an electrical current when a fault is present, for example an overcurrent and/or a short-circuit current. Alternatively or in combination therewith, the electrical current flow is interrupted with the aid of the circuit-breaker when an existing electrical voltage is excessive or if the presence of an arc was detected. The circuit-breaker advantageously includes a sensor for this purpose, with the aid of which, in particular, the possible fault may be detected. The sensor is suitably used to detect a state of the circuit-breaker and/or of the electrical current conducted with the aid of the circuit-breaker. Multiple corresponding sensors are advantageously present, so that a comparatively accurate determination of different faults is made possible. For example, one of the sensors is designed as a voltage sensor and the other as a current sensor.

The circuit-breaker suitably can comprise a control unit, which is connected via signals to the sensor. The switching device is actuated with the aid of the control unit, preferably as a function of measurement data captured with the aid of the sensor, and/or if the fault was detected. For this purpose, the measurement data provided with the aid of the sensors are advantageously evaluated with the aid of the control unit. If the fault is present, in particular, the mechanical switch is opened with the aid of the control unit and thus placed in the non-conductive state. In particular, current is supplied to the drive accordingly.

The refinements and advantages explained in connection with the switching device are to be similarly transferred to the circuit breaker as well as to each other and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a DC circuit having a load and a circuit-breaker, which comprises a switching device;

FIGS. 2 and 3 show a perspective view and a sectional representation, respectively, of the circuit-breaker, including the switching device, which comprises a mechanical switch having a moving contact and a fixed contact and comprises an apparatus for compensating for a burn-off of the moving contact and/or the fixed contact;

FIG. 4 shows a sectional representation of a contact bridge, which is movably supported on a contact bridge carrier and comprises the moving contact;

FIGS. 5 through 8 each show a sectional representation of examples of the apparatus;

FIG. 9 shows a further sectional representation of the apparatus according to FIG. 8; and

FIG. 10 shows a perspective view of an example of the apparatus, which comprises a holder.

### DETAILED DESCRIPTION

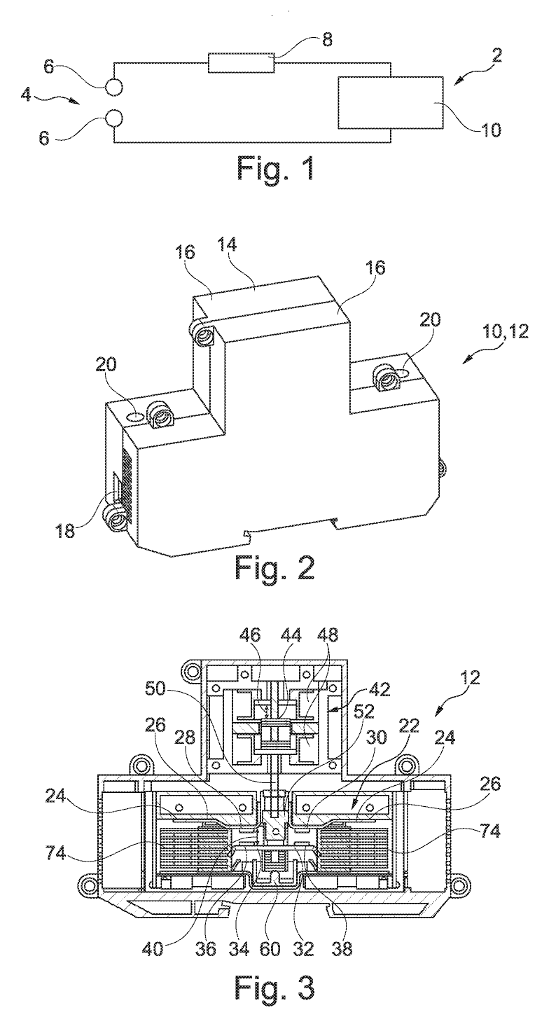

FIG. 1 shows a schematically simplified view of a DC circuit 2, which comprises a DC voltage source 4. An electrical DC voltage of 650 V is provided with the aid thereof, which is present between poles 6 of DC voltage source 4. A load 8 is electrically connected directly to one of poles 6 and via a circuit-breaker 10 to the other one. A circuit is thus formed.

FIG. 2 shows a perspective view of circuit-breaker 10, which comprises a switching device 12. Switching device 12 has a housing 14 with two housing halves 16, which are joined together and are manufactured from a plastic. Two openings are introduced into housing 14, within each of which a device connection 18 is arranged. The connection of an electrical cable leading to DC voltage sources 4 and load 8, respectively, is made possible here. Device connections 18 each have clamping screws, which are accessible through a particular mounting opening 20 of housing 14. The cable assigned to particular device connection 18 is clamped and therefore electrically contacted by screwing in the clamping screws.

Switching device 12 is illustrated in a sectional representation in FIG. 3. It has a mechanical switch 22, which is arranged within housing 14 and comprises two connections 24, which are situated at a distance from each other. Connections 24 each comprise a connection body 26, which is designed as a busbar and is made from a tin-plated copper. The two connection bodies 26 are essentially arranged in a shared plane, and each connection body 26 is electrically connected to one of device connections 18 by means of a cable. A fixed contact 28 is permanently welded to one of connection bodies 26 and a further fixed contact 30 to the other, which are made from a comparatively burn-off-resistant and electrically conductive material.

Mechanical switch 22 also includes a contact bridge 32, which comprises an essentially strip-shaped bridge body 34, which is also made from a tin-plated copper. A moving contact 36 and a further moving contact 38 are welded to bridge body 34, which are made from the same material as the two fixed contacts 28, 30. Contact bridge 32 is movably supported along a second adjustment path 40, which is essentially perpendicular to the extension of bridge body 34 and is in a straight line. When contact bridge 32 is at an end of second adjustment path 40, moving contact 36 rests against fixed contact 28, and further moving contact 38 mechanically rests against further fixed contact 30, and mechanical switch 22 is in a closed state. At the other end of second adjustment path 40, however, moving contacts 36, 38 are situated at a distance from fixed contacts 28, 30, and mechanical switch 22 is in an opened state.

When mechanical switch 22 is in the closed state, the two device connections 28 are electrically conductively connected, and an electrical current is conducted over contact bridge 32. When mechanical switch 22 is in the opened state, the two device connections 18 are galvanically isolated from each other. An electrical current is no longer conducted over contact bridge 32.

Switching device 12 also has an electrical drive 42, which is likewise arranged in housing 14. Electrical drive 42, which is also referred only as drive 42, is operated with the aid of a control unit of circuit-breaker 10, which is also arranged in housing 14. The control unit is connected via signals to a sensor, and with the aid of which the electrical current conducted by means of switching device 12 may be characterized and/or detected. Electromechanical drive 42 is operated as a function of measurement data detected with the aid of the sensor.

Drive 42 includes an armature 44, which is movably supported along a first adjustment path 46. First adjustment path 46 is in parallel to second adjustment path 40, but is slightly longer than the latter. Drive 42 is designed as a moving magnet actuator and includes two electrical coils 48, which are arranged concentrically to each other, but are offset from each other along first adjustment path 46. Armature 44 is surrounded by electrical coils 48 on the circumferential side. Armature 44 is fastened to an actuating rod 48 arranged in parallel to first/second adjustment path 46, 40, which, in turn, is rigidly connected to a slide 50 on an end side.

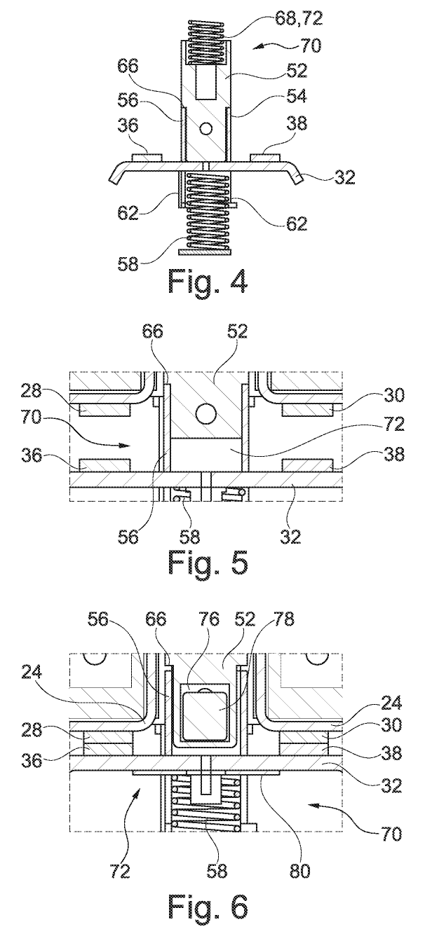

Slide 52, which is also illustrated in an enlargement along opening direction 40 in the sectional representation in FIG. 4, is inserted into a receptacle 54 of an essentially cuboid contact bridge carrier 56, which is manufactured from a plastic. The cuboid shape extends along second adjustment path 40, and the two end faces are open, so that contact bridge carrier 56 is hollow cylindrical with a rectangular cross-section. Receptacle 54, into which slide 52 is inserted in opening direction 40, is provided by means of one of the end faces. A return spring 58, which is supported on contact bridge 32 and a holder 60, protrudes through opposing end face. Holder 60 is formed by means of housing 14, so that return spring 58 is supported on housing 14.

Contact bridge 32 is supported on contact bridge carrier 56. Contact bridge carrier 56, namely opposing longitudinal sides, have congruent guide slots 62 for this purpose, so that a through-opening 64 is formed. Contact bridge 32 is guided through through-opening 64, so that it has a projections on each side of contact bridge carrier 56, i.e., perpendicularly to second adjustment path 40. One of the projections includes moving contact 36 and the other includes further moving contact 38. Due to guide slots 62, it is possible to move contact bridge 32 in relation to contact bridge carrier 56 in parallel to second adjustment path 40.

Slide 52 is inserted only loosely into receptacle 54, so that it is possible to move it at least partially out of contact bridge carrier 56, a complete removable not being possible. Pushing slide 52 too far into contact bridge carrier 56 is also avoided with the aid of corresponding stops 66 of slide 52 and contact bridge carrier 56. For this purpose, slide 52 has a outwardly protruding step, which may be placed on the edge of contact bridge carrier 56. However, only a relative movement thereof in parallel to first/second adjustment path 46, 40 is possible, and slide 52 is guided on contact bridge carrier 56, on which contact bridge 32 is held. Due to a construction of this type, it is also possible to move contact bridge 32 in relation to armature 44 in parallel to first/second adjustment path 46, 40.

A spring 68 is connected to slide 52 on the side opposite contact bridge 56. Spring 68 is arranged in parallel to first/second adjustment path 46, 40 and surrounds actuating rod 50, so that the position of spring 68 is permanently predefined. The free end of spring 68 opposite slide 52 is loose in the opened state of mechanical switch 22. In the closed state of mechanical switch 22, on the other hand, this free end is supported on housing 14 or on a part of electrical drive 42, so that a force is applied to slide 52 thereby.

Armature 44 is situated on an end of first adjustment path 46 in the opened state of mechanical switch 22. Slide 52 is supported on contact bridge 32 on the end opposite armature 44, stops 66 of slide 52 and contact bridge carrier 56 resting against each other. Return spring 58 is compressed with the aid of contact bridge 32.

To place mechanical switch 22 in the closed state, armature 44 is moved along first adjustment path 46, for which purpose, in particular, current is supplied to electrical coils 48. It is possible only to move armature 44 to the opposite end of first adjustment path 46. As a result, slide 52 and spring 68 are also moved, the latter being moved against electrical drive 42 or housing 14 and thus compressed. Due to the loose interconnection, however, a transfer of force to contact bridge carrier 56 with the aid of electrical drive 42 is not possible. However, a counter-force now no longer acts upon return spring 58, and the latter relaxes, which results in a movement of contact bridge 32 along second adjustment path 40, until moving contacts 36, 38 rest against fixed contacts 28, 30. The contact bridge carrier is also carried along by contact bridge 32. Since first adjustment path 46 is longer than second adjustment path 40, the two stops 66 are moved away from each other. In other words, slide 52 is moved farther than contact bridge carrier 56.

Once the supply of current to electrical drive 42 has ended, a force is no longer applied thereby to armature 44, but spring 68 acts upon slide 52, which results in a slight movement of slide 52 and therefore also armature 44 along first adjustment path 46. The movement is ended once slide 52 has been moved against contact bridge 32. A further movement is prevented with the aid of return spring 58. A closed state is thus implemented.

If mechanical switch 22 is in the closed state and is to be opened, current is supplied to electrical drive 42. As a result, a magnetic field is provided with the aid of electrical coils 48, which interacts with armature 44 and sets the latter in motion, namely along first adjustment path 46 in the direction of contact bridge 32. Since slide 52 already rests against contact bridge 32, this results in a start of the movement of contact bridge 32, which is thus moved synchronously with armature 44.

In summary, switching device 12 is thus designed in such a way that, when mechanical switch 22 is in the closed position, a start of the movement of armature 44 results in a start of the movement of contact bridge 32. Armature 44 is rigidly fastened to slide 52. Spring 68, on which slide 52 is supported in the closed state of mechanical switch 22, is used to move slide 52 against contact bridge 32 in the closed state of mechanical switch 22, regardless of whether a burn-off of moving contacts 36, 38 or fixed contacts 28, 30 is present. If they have a comparatively great burn-off, the size thereof is reduced, and contact bridge 32 is thus moved in the direction of electrical drive 42. Spring 68 is thus a constituent part of an apparatus 70 for compensating for a burn-off of moving contacts 36, 38 and fixed contacts 28, 30. Spring 68 forms a compensation element 72 for moving slide 52 against contact bridge 32 in the closed state of mechanical switch 22.

In an example, spring 68 is, for example, only loosely set onto actuating rod 50 or fastened to electrical drive 42 or housing 14 on the end opposite slide 52. In a further alternative, the spring is, for example, supported on the side of electrical drive 42 opposite the slide directly on actuating rode 50 and this indirectly on slide 52.

If arcs should form between moving contacts 36, 38 and particular assigned fixed contact 28, 30 during the opening of mechanical switch 22, they are assigned to arc chutes 74, which include multiple quenching plates stacked one on top of the other. Arc chutes 74 also comprise blowout arrangements for moving the particular arc between the quenching plates. Once the arc occurs, a thermal load on moving contacts 36, 38 and fixed contacts 28, 30 occurs, which are partially melted/deformed.

FIG. 5 shows a modified example of apparatus 70. Contact bridge 32 and contact bridge carrier 56 as well as return spring 58 are not changed. However, spring 68 is now no longer present, and slide 52 is shortened, so that its end face is situated at a distance from the contact bridge when the two stops 66 rest against each other. Compensation element 72 is now arranged there. In an example, the latter is manufactured from an elastomer and is fastened to slide 52 as well as contact bridge 32, namely glued or materially bonded in another manner. Slide 52 is thus always moved against contact bridge 32, and it is also possible to apply a force to contact bridge 32 with the aid of electrical drive 42 to place mechanical switch 22 in the closed state. When armature 44 is moved to the end of first adjustment path 46, compensation element 72 is elongated once contact bridge 32 has reached the end of second adjustment path 40. When the supply of current to electrical drive 42 has then ended, compensation element 72 is again compressed, and slide 52 and armature 44 are moved in the direction of contact bridge 32.

Once current is supplied to electrical drive 42 to open mechanical switch 22, the force is transferred via slide 52 and compensation element 72 to contact bridge 32 essentially unhindered, so that the latter is also moved. The elastomer is designed, in particular, in such a way that the shear modulus is comparatively high, so that a deformation of compensation element 72 essentially does not occur during this comparatively fast movement. In addition, a deformation is completely avoided by means of the walls of contact bridge carrier 56, against which compensation element 72 rests in the compressed state. The force provided with the aid of electrical drive 42 is fully transferred to contact bridge 32.

In an example, compensation element 72 is replaced and made from a shape memory material, namely a magnetic shape memory material. In one alternative, the latter comprises a magnetorheological fluid, which is arranged, in particular, in a flexible container, which is manufactured, for example, from a rubber. Compensation element 72 in this case as well, namely the shape memory material or the container, is fastened to slide 52 as well as to contact bridge 32. A movement of contact bridge 32 in relation to armature 44 is also made possible here in each case.

When mechanical switch 22 is in the opened state, a magnetic field is not present in the region of compensation element 72. In this case, it is possible, in particular, to elongate the shape memory material or the flexible container, since the magnetorheological fluid has a comparatively high viscosity. Once mechanical switch 22 is in the closed state, an electrical current is conducted over contact bridge 32. This results in the fact that contact bridge 32 is surrounded by a magnetic field, which is thus also penetrated by compensation element 72. As a result. the shape memory material is compressed, which causes slide 52 to be moved in the direction of contact bridge 32 until stops 66 rest against each other. If compensation element 72 comprises the magnetorheological material, the magnetic field causes the viscosity to decrease, so that the material is present, for example, as a solid or at least behaves similarly to a solid. If current is then supplied to electrical drive 42 for the purpose of opening mechanical switch 22, slide 52 again already rests against contact bridge carrier 56, and the free space formed between slide 52 and contact bridge 32 is filled completely with compensation element 72, which is thus unable to deform any further, provided that it comprises the shape memory material. If the latter comprises the magnetorheological fluid, compensation element 72 is rigid. In both cases, this causes the movement of armature 44 to result in the start of the movement of contact bridge 32. A deformation of compensation element 72 is again possible only if the electrical current over contact bridge 32 is interrupted and the magnetic field surrounding contact bridge 32 has collapsed, so that a relative movement of contact bridge 32 in relation to armature 44 may take place.

A further alternative of apparatus 70 is illustrated in FIG. 6, the mechanical switch being shown in the closed state. Contact bridge 32, return spring 58, and contact bridge carrier 56 are not changed. Slide 52 has a design essentially the same as the variable illustrated in FIG. 4, so that it rests against contact bridge 32 on the end face when its stop 66 rests against stop 66 of contact bridge carrier 56.

Compensation element 72 is modified and includes a first magnet element 78, which is provided with the aid of a permanent magnet. Slide 52 has a receiving opening 76, which is opened perpendicularly to second adjustment path 40 and within which first magnet element 78 is inserted. First magnet element 78 is thus assigned to slide 52. Compensation element 72 also includes a second magnet element 80, which is implemented with the aid of an iron or steel wafer. At least second magnet element 80 is manufactured from a ferromagnetic material and arranged on the side of contact bridge 32 opposite slide 52 as well as in parallel thereto. Second magnet element 80 rests against contact bridge 32, to which it is fastened, namely glued. Second magnet element 80 is also pressed against contact bridge 32 with the aid of return spring 58. Second magnet element 80 is therefore assigned to contact bridge 32.

The forces active between first and second magnet elements 78, 80 are comparatively low, so that, during the closing of mechanical switch 22, a detachment of slide 52 from contact bridge 32, and therefore also the movement of armature 44 to the end of adjustment path 46, is possible. However, once the supply of current to electrical drive 42 has ended, slide 52 is moved against contact bridge 32 due to the forces active between first and second magnet elements 78, 80. Compared to the example including spring 68, on contact bridge 32, only the forces provided with the aid of return spring 58 on contact bridge 32 relative to housing 14 are active when no current is supplied to electrical drive 42.

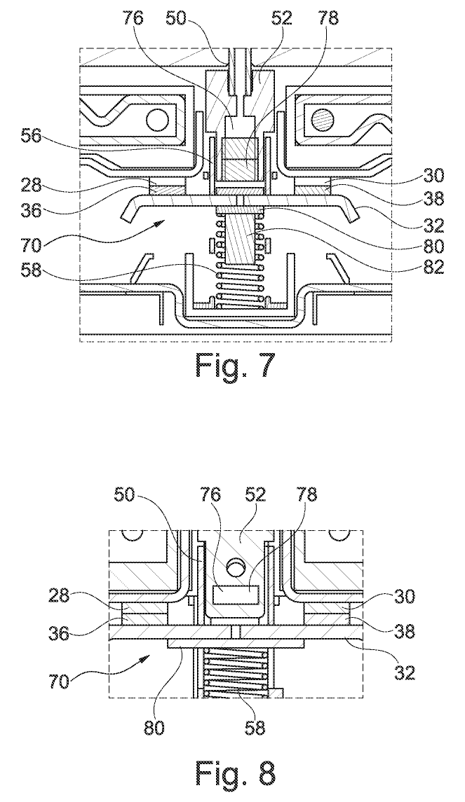

FIG. 7 shows a further example of apparatus 70. Compensation element 72 still comprises first magnet element 78, which is now implemented with the aid of two permanent magnets stacked one on top of the other, which are fastened in receiving opening 76 of slide 52, which is open on the end face. The permanent magnets are stacked one on top of the other, so that a comparatively strong magnetic field is provided. Second magnet element 80 is designed in the manner of a ring and surrounds contact bridge 32 on the circumferential side. The ring is manufactured from a suitably bent metal band made from a ferromagnetic material, namely iron. Second magnet element 80 is thus also situated on the side of contact bridge 32 facing first magnet element 78, for which reason their interaction is increased. A captive connection to contact bridge 32 is given. In the variant illustrated in FIG. 7, second magnet element 80 also includes a further permanent magnet 82, which is situated on the side of contact bridge 32 opposite slide 52 and is fastened to contact bridge 32 via the metal ring of second magnet element 80. Further permanent magnet 82 is surrounded by return spring 58 on the circumferential side and is thus protected and stabilized. Due to further permanent magnet 82, the magnetic forces active between first and second magnet elements 78, 80 are intensified, the magnetic field lines being suitably formed with the aid of the metal ring of second magnet element 80.

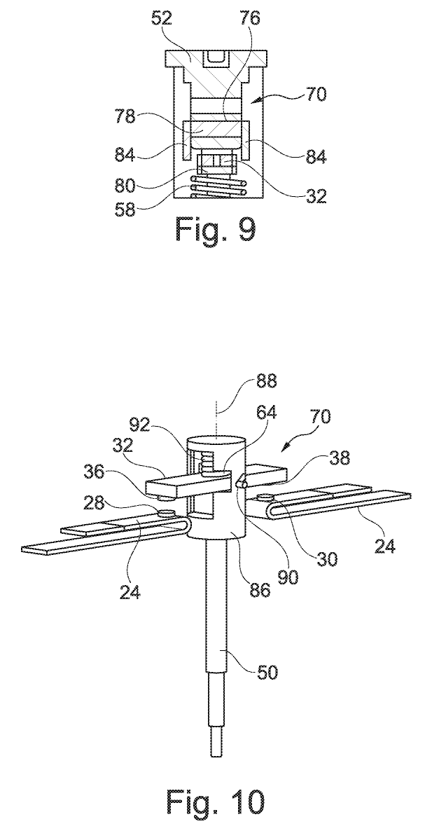

A modification of apparatus 70 is illustrated in FIG. 8 in a further sectional representation along second adjustment path 40. Apparatus 70 is again illustrated in FIG. 9 in a sectional representation running perpendicularly thereto and in parallel to second adjustment path 40. Slide 52 again has receiving opening 76, which is offset away from the end face and essentially corresponds to a narrowed variant of the example of receiving opening 76 illustrated in FIG. 6. A part of first magnet 78 is situated therein in a form-fitting manner, by means of which receiving opening 76 is completely filled.

Continuations 84 are connected to the end faces of the part of first magnet element 78 situated in receiving opening 76, which each run perpendicularly thereto and in the direction of contact bridge 32. Entire first magnet element 78 is made from a ferromagnetic material, namely iron, and continuations 84 encompass contact bridge 32 on the free end side when slide 52 rests against contact bridge 32. The free ends of continuations 84 are thus situated essentially next to second magnet element 80, which corresponds to the variant illustrated in FIG. 6. Second magnet element 80 is thus also arranged on the side of contact bridge 32 opposite slide 52 and is made from the iron.

Once the electrical current is conducted with the aid of contact bridge 32, the latter is surrounded by the magnetic field induced thereby, which is guided by first magnet element 76 around contact bridge 32 in a U-shaped manner, where it is guided with the aid of second magnet element 80. To reduce the air gaps formed between first and second magnet elements 78, 80, the free ends of continuations 84 are arranged essentially next to second magnet element 80, which results in the movement of slide 52 against contact bridge 32. Once again, return spring 58 is present here, with the aid of which second magnet element 80 is pressed against contact bridge 32.

A further modification of switching device 12 is illustrated sectionally in FIG. 10, apparatus 70 being modified. Actuating rod 50 runs in the illustrated perspective. It is again rigidly connected to armature 44 of electrical drive 42. On the end opposite armature 44, an essentially cylindrical holder 86 is rotatably supported around a rotation axis 88, on which actuating rod 50 is situated. Holder 86 is thus rotatable around rotation axis 88, which runs in parallel to second adjustment path 40.

Holder 86 is manufactured from a plastic and also has through-opening 64 running perpendicularly to second adjustment path 40 and through which contact bridge 32 is inserted. Contact bridge 32 is supported in two opposing retaining contours 90 of holder 86, which each run helically around rotation axis 88. Retaining contours 90 are provided by means of helical slots, in which stubby continuations of contact bridge 32 are arranged. A movement of contact bridge 32 in relation to holder 86 is thus possible in parallel to longitudinal axis 88, contact bridge 32, however, being simultaneously rotated around rotation axis 88 in relation to holder 86.

Contact bridge 32 is supported on and with the aid of a pressure spring 92 arranged between the contact bridge and an inner base of holder 86 and is thus spring-loaded. It is ensured with the aid of a guide of housing 14 that a rotation of contact bridge 32 in relation to housing 14 does not occur.

For example, return spring 58 is not present in this variant of switching device 12. Electrical drive 42 is also modified, and armature 44 is always moved to the ends of first adjustment path 46 and held there. Armature 44 is thus also situated at one of the ends of first adjustment path 46 when mechanical switch 22 is in the closed position. In this case, pressure spring 92 is compressed to its maximum extent or at least to a comparatively great degree. If a burn-off of contacts 28, 30, 36, 38 should be present, contact bridge 32 is moved in retaining contours 90 with the aid of pressure spring 92 until moving contacts 36, 38 rest against fixed contacts 28, 30, holder 86 being rotated around rotation axis 88.

To open mechanical switch 22, armature 44 is moved along entire first adjustment path 46. This results in an adjustment of holder 86 and contact bridge 32 along second adjustment path 40. The friction prevailing between holder 86 and actuating rod 50 as well as the friction prevailing between contact bridge 32 and holder 86 are comparatively high, for which reason a relative movement of contact bridge 32 in relation to holder 86 essentially does not take place. Once again, the start of the movement of armature 44 thus results in the start of the movement of contact bridge 32 in this case as well. Only after the conclusion of the movement of contact bridge 32 along second adjustment path 40 is the (static) friction overcome, which results in a gradual relaxation of pressure spring 92 and a rotation of holder 86 around rotation axis 88.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A switching device comprising:
an electrical drive, which includes an armature, movably supported along a first adjustment path;
a mechanical switch that includes a fixed contact and a contact bridge with a moving contact, the contact bridge being movably supported in relation to the fixed contact along a second adjustment path such that the moving contact rests against the fixed contact in a closed state of the mechanical switch, the moving contact being arranged at a distance from the fixed contact in an opened state, and the contact bridge being movably supported in relation to the armature; and
an apparatus to compensate for a burn-off of the moving contact and/or the fixed contact,
wherein the switching device is designed such that, when the mechanical switch is in the closed state, a start of a movement of the armature results in a start of the movement of the contact bridge.

2. The switching device according to claim 1, wherein the armature (44) is rigidly fastened to a slide (52), the apparatus (70) comprising a compensation element (72) for moving the slide (52) against the contact bridge (32) in the closed state of the mechanical switch (22).

3. The switching device according to claim 2, wherein the slide (52) is guided on a contact bridge carrier (56), on which the contact bridge (32) is held.

4. The switching device according to claim 2, wherein the compensation element (72) comprises a spring (68), on which the slide (52) is supported in the closed state of the mechanical switch (22).

5. The switching device according to claim 2, wherein the compensation element (72) comprises a first magnet element (78) assigned to the slide (52) and a second magnet element (80) assigned to the contact bridge (32).

6. The switching device according to claim 5, wherein the second magnet element (80) is arranged on the side of the contact bridge (32) opposite the slide (52).

7. The switching device according to claim 5, wherein the contact bridge (32) is surrounded by the second magnet element (80) on the circumferential side.

8. The switching device according to claim 2, wherein the compensation element (72) comprises an elastomer, via which the slide (52) is connected to the contact bridge (32).

9. The switching device according to claim 2, wherein the compensation element (72) comprises a shape memory material and/or a magnetorheological fluid, via which the slide (52) is connected to the contact bridge (32).

10. The switching device according to claim 1, wherein the armature (44) is connected to a holder (86), which is rotatable around a rotation axis (88) running in parallel to the second adjustment path (40), the contact bridge (32) being supported in a retaining contour (90) of the holder (86), which runs helically around the rotation axis (88), and is supported on and with the aid of a pressure spring (92).
